(19) United States
(12) Patent Application Publication
(10) Pub. No.: US 2012/0244296 A1
(43) Pub. Date: Sep. 27, 2012

(54) PROCESS FOR MANUFACTURING A PAPER PRODUCT, THE PAPER PRODUCT AND A HYBRID COATING

(75) Inventors: Nina Pykäläinen, Lappeenranta (FI); Pasi Virtanen, Lappeenranta (FI)

(73) Assignee: UPM-Kymmene Corporation, Helsinki (FI)

(21) Appl. No.: 13/496,268

(22) PCT Filed: Sep. 14, 2010
(86) PCT No.: PCT/FI10/50705

§ 371 Date: May 31, 2012

(30) Foreign Application Priority Data
Sep. 18, 2009 (FI) 20095961

(51) Int. Cl. B41M 5/52; B05D 7/00; B05D 3/12; B05D 1/02; C09D 101/08; B05D 1/30; B32B 5/00; B32B 29/06; C09D 103/02; C09D 129/04; B05D 1/36; B05D 1/28

(52) U.S. Cl. 428/32.11; 427/402; 427/415; 427/356; 428/341; 106/206.1; 524/557; 106/163.01

(57) ABSTRACT

The invention relates to a process for forming a paper product, wherein a base paper is formed from fiber based raw material, and the base paper is coated to form the paper product. According to the invention, a treatment material layer which contains a cationic compound is provided on the base paper, at least on one of its surfaces, and a coating layer is provided on the cationic treatment material layer. In addition, the invention relates to the corresponding paper product, the hybrid coating and the process for providing the hybrid coating to paper.

### FIELD OF THE INVENTION

The invention relates to the process for manufacturing a paper product as defined in claim 1, to the paper product as defined in claim 10, to the hybrid coating as defined in claim 18, and to the process for providing the hybrid coating to the surface of base paper as defined in claim 25.

### BACKGROUND OF THE INVENTION

Known from the prior art are various processes for manufacturing different kinds of papers that are applicable for printing. In addition, known from the prior art are various printing processes, e.g. offset printing, digital printing, such as inkjet printing, and the rotogravure technique. In printing, it is important to achieve adequately good and sharp impression according to the purpose of use of the printing product. Different types of papers are typically used in different printing processes. Hence, there are many different types of printing papers.

The papers applicable for printing are conventionally coated with a surface-size mixture and/or a pigmented coating mixture. It is known that water-fastness of impression in inkjet paper may be improved by adding cationic polymers to the surface-size or the coating on the surface of paper. The most commonly used polymer is polyDADMAC. Patent applications WO 2006067273 and US 2004/0033377 disclose the treatment of the surface in printing paper with a cationic polymer in association with a surface-sizing treatment of the paper. Publication WO 2006067273 suggests 2 g/m² as the optimal amount, in which case about half of the amount of surface-size should be replaced with the cationic polymer. The amount of cationic polymer as presented above increases the production costs of printing paper. Publication US 2004/0033377 discloses a surface-size mixture containing a cationic polymer and optionally also a pigment and a binder. Known from publication WO 2006116878 is the addition of a cationic polymer to the coating mixture. It is known from the art that the addition of a cationic polymer to the coating mixture may cause precipitation with anionic compounds of the coating mixture, which causes problems in the process.

### OBJECTIVE OF THE INVENTION

An objective of the invention is to eliminate the drawbacks referred to above. Furthermore, an objective of the invention is to disclose a new process for manufacturing a paper product, and the corresponding multi-function paper product which is suited to be used in many different printing processes. In addition, an objective of the invention is to bring a new type of a coating solution to manufacture a paper product applicable for printing. Especially, an objective of the invention is to disclose a new manner of providing printability to a paper product.

### SUMMARY OF THE INVENTION

The process for manufacturing a paper product, the paper product, the hybrid coating and the process for providing the hybrid coating to paper according to the invention are characterized by what is presented in the claims.

The invention is based on a process for forming a paper product, wherein a paper product that is applicable for printing is formed by forming a base paper from fiber-based raw material and by coating the base paper. According to the invention, a treatment material layer which contains a cationic compound is provided on the base paper, at least on one of its surfaces, to form a cationic treatment material layer, and a coating layer is provided on the cationic treatment material layer.

Furthermore, the invention is based on a paper product which may be used as printing paper. The paper product comprises a base paper which is formed from fiber-based raw material, and a coating provided to the surface of the base paper. According to the invention, a treatment material layer which contains a cationic compound is provided on the base paper, at least on one of its surfaces, and a coating layer is provided on the cationic treatment material layer. In this context, the layer structure in question is a coating. Preferably, the coating is provided on the base paper by inserting the treatment material layer between the base paper and the coating layer.

In addition, the invention is based on a hybrid coating which may be provided to at least one surface of a base paper which is formed from fiber-based raw material. According to the invention, the hybrid coating contains at least two layers, wherein the first layer is a treatment material layer which contains a cationic compound and the second layer is a coating layer. In addition, the invention is based on a process for providing the hybrid coating to the surface of a base paper in one or more steps.

The invention is specifically based on a paper product and its surface treatment through multi-layer processing, so that the same paper product is suited to be used in many printing processes, e.g. in inkjet, offset and rotogravure processes. In addition, the basic idea of the invention is the combination of a cationic treatment material layer and a coating layer. The paper product according to the invention has good printability properties.

Printability properties stand for quality of impression, fastness to water and/or amount and speed of absorption of color. Quality of impression stands for sharpness and/or evenness of impression.

A paper product in this context stands for any fiber-based paper, board or fiber product or equivalent. The base paper may be formed from any fiber-based pulp, such as chemical pulp, mechanical pulp, chemi-mechanical pulp, recycled pulp, fiber pulp and/or their mixtures or equivalent. The base paper may be in the form of a wet web, a dry web or a sheet or in other form suitable for the purpose of use. The base paper may contain suitable fillers, binders and additives.

In one embodiment the base paper is selected from the group of fine paper, such as WFU or UWF, paper manufactured from mechanical pulp, such as LWC or SC, newsprint, paper manufactured from recycled fibers, different self-adhesive papers and the equivalent papers.

In one preferred embodiment of the invention the cationic treatment material is a cationic surface-size, and a cationic surface-size layer is provided on the base paper, at least on one of its surfaces, and a coating layer is provided on the cationic surface-size layer.

In one embodiment of the invention the cationic surface-size layer contains a cationic polymeric and/or a cationic ionic compound that may be any cationic compounds known per se and suitable for the purpose of use.

In one preferred embodiment of the invention the cationic treatment material layer contains a binder in addition to the cationic compound. The cationic compound may be any cationic compound suitable for the purpose of use. In one embodiment the binder is selected from the group of starch, starch-based compounds, carboxy-methyl cellulose, polyvinyl alcohol, latex dispersion and their derivatives and the mixtures of different binders. In one preferred embodiment the treatment material layer contains a cationic compound and starch or a starch-based compound. In addition, the treatment material layer may contain different fillers and additives, conventionally no pigment. In one alternative embodiment the treatment material layer may contain pigment, preferably in small amounts. In one embodiment the treatment material layer contains 100 parts of a binder and 10 to 100 parts of a cationic compound, depending on the cationic compound used.

In one embodiment the treatment material mixture that forms the treatment material layer is in the form of a solution, a dispersion or a foam or in other suitable form. The treatment material mixture may be provided or spread to the surface of the base paper in any manner known per se in the art. In one embodiment the treatment material mixture is provided to the surface of the obtained base paper web in connection with web formation, e.g. in connection with drainage. In one embodiment the treatment material mixture is provided to the surface of the obtained web in a separate step after web formation. The treatment material mixture may be spread on either a dry or a wet surface.

In one embodiment of the invention the amount of the cationic treatment material layer is 0.5 to 3 g/m².

In one embodiment of the invention the coating layer contains a pigment, such as calcium carbonate, kaoline, talc, titanium dioxide or their mixtures or other equivalent pigment known in the art and suitable for the purpose of use, and a binder, such as starch, protein, latex, carboxy-methyl cellulose or their derivatives or their mixtures or an equivalent binder known in the art. In addition, the coating layer may contain additives suitable for the purpose of use, e.g. hardeners, lubricants, anti-foam agents, conserving agents, pH modifiers and viscosity modifiers. Inexpensive standard pigments used in the art may be used in the coating in the solution according to the invention. Any coating mixture suitable for the purpose of use may be used in the coating layer. Coating in this context stands for both the conventional coating embodiment and the pigmenting embodiment as well as embodiments based on them. In one embodiment the coating layer contains 100 parts of a pigment and 5 to 50 parts of a binder.

In one embodiment of the invention the amount of the coating layer is 3 to 12 g/m². In one embodiment the amount of the coating layer is 4 to 10 g/m². In one embodiment the amount of the coating layer is 5 to 8 g/m².

In one embodiment the coating layer may be spread on the treatment material layer in the same process step. In one embodiment the coating layer and the treatment material layer may be spread on the base paper substantially simultaneously. In an alternative embodiment the coating layer may be spread on the treatment material layer in a separate process step. In one embodiment the treatment material layer is formed in a precoating step.

In one embodiment of the invention at least one additional layer is provided between the base paper and the cationic treatment material layer. Preferably, the additional layers are provided under the treatment material layer, i.e. between the base paper and the treatment material layer.

In one preferred embodiment of the invention the coating layer is provided substantially upon the treatment material layer. The coating layer may be spread to dry or wet surface of the treatment material layer.

The spreading of the treatment material and the coating layers to the surface of the base paper may be made in same or different steps in manners completely known per se in the art, e.g. by blade coating, film coating, curtain coating, spray coating, multiple coating, multiple curtain coating, sizer coating, dry coating, pond size pressing, film transfer size pressing or their combinations or in other suitable manner.

In one process embodiment the base paper web is formed in a manner known per se. The web is coated with the treatment material mixture and the coating mixture according to the invention. The web is cut, if desired, in sheets or equivalent, and a desired impression is made in the desired manner to the web or the printing products cut from it.

In one embodiment the printing to the paper product according to the invention may be made by a digital, such as inkjet or high speed inkjet, offset, such as HSWO, or rotogravure process or by an equivalent printing technique. In inkjet printing the inks penetrate the coating layer, and the absorption of the inks stops at the cationic treatment material layer.

Important advantages are achieved by the process, the paper product and the hybrid coating according to the invention as compared with the prior art.

The invention provides a multi-function paper product of good quality which is suited to different printing applications and which has good printability properties and wherein a good impression is provided.

Thanks to the invention, the changing of type in papermaking, e.g. from inkjet type to offset type, becomes flexible and quick because the same paper product according to the invention may be used in different printing applications. A problem in papermaking has previously been the changing of type because in large machines it has been slow and there has been a lot of loss. In using the invention, the paper type may be changed, e.g. from offset type to inkjet type, and production of the desired paper product may be continued without interruption. In this case, the need for washing and the risk of flocculation in the coating mixture circulation and at the wet end are reduced. Alternatively, in connection with changing the type, the feed of the cationic treatment material layer to the surface of the base paper may be stopped in making a paper product in which a cationic layer is not needed.

Thanks to the paper product according to the invention, also inexpensive colors, e.g. water-based inkjet colors, may be used in printing.

An industrially applicable easy manner of manufacturing a paper product that is applicable for many different types of printing is achieved by the invention. At the same time, an easy, simple and inexpensive manner of carrying out printing is achieved by the invention, thanks to the paper product according to the invention. The paper product according to the invention is suited to offset as well as inkjet printing and to other printing methods. The paper product according to the invention does not limit the manufacture of the main product, i.e. the printing product.

### DETAILED DESCRIPTION OF THE INVENTION

### Example 1

In the experiments of this example, printability of the paper product according to the invention was examined on a laboratory scale.

45 g/m² of LWC paper was used as base paper. A cationic surface-size layer which contained 100 parts of starch and 100 parts of a cationic polymer was provided to one surface of the base paper. Cartafix DPR was used as the cationic polymer. The amount of the surface-size layer was 1.7 g/m². A coating layer which contained 100 parts of a standard pigment and 10 parts of a binder was provided on the cationic surface-size layer. 80 parts of carbonate and 20 parts of kaoline was used as the pigment, and latex was used as the binder. The surface-size layer was spread to the surface of the base paper by precoating. The coating layer was spread on the surface-size layer in a separate step. The amounts of the coating layers were 3, 7 and 12 g/m². The coated papers were calandered to a gloss level of 40%. Important properties for HSWO type, such as picking resistance, were tested from the papers. The papers were also printed with the Kodak Versamark high speed inkjet technique, using typical inkjet inks. Important properties for inkjet papers, such as fastness to water, wet rub resistance and the water bleed feature, were analyzed from the printed papers.

In the experiments it was discovered that, with all coat weights, good fastness to water, wet rub resistance and water bleed which represents spreading of ink from printed area to blank area in wet paper were achieved for the printed paper product according to the invention. Picking resistance in the obtained paper product was discovered as being on a level equivalent to the standard picking resistance of offset paper. IGT picking resistance (based on standard ISO 3783:2004) was even discovered as being on a higher level. Also, absorption of inkjet color was discovered as being on an adequate level, corresponding to absorption of color in offset paper. The gloss, smoothness and optical properties were at an adequate level, considering the paper product criteria. It was discovered that the cationic layer functions well under the coating layer. In addition, it was discovered in the experiments that a thicker amount of the coating layer weakened the printability of inkjet paper, e.g. an amount of the coating layer of 7 g/m² was more advantageous than 12 g/m² for absorption of color.

In conclusion of the experiments, there was achieved a multifunctional paper product, the properties of which fulfilled the quality criteria of the paper product regarding both inkjet and offset printing.

The process in accordance with the invention is suitable in different embodiments to be used for making most different kinds of paper products. The paper product and the hybrid coating according to the invention are suitable in different embodiments to be used for making most different kinds of printing products.

The invention is not limited merely to the examples referred to above; instead, many variations are possible within the scope of the inventive idea defined by the claims.

1. A process for forming a paper product, wherein a base paper is formed from fiber-based raw material, and the base paper is coated to form the paper product, wherein a treatment material layer which contains a cationic compound is provided on the base paper, at least on one of its surfaces, and a coating layer is provided on the cationic treatment material layer.

2. The process according to claim 1, wherein the cationic treatment material is a cationic surface-size, and a cationic surface-size layer is provided on the base paper, at least on one of its surfaces, and the coating layer is provided on the cationic surface-size layer.

3. The process according to claim 2, wherein the cationic surface-size layer contains a cationic polymeric and/or a cationic ionic compound.

4. The process according to claim 1, wherein the cationic treatment material layer contains a binder in addition to the cationic compound.

5. The process according to claim 1, wherein the coating layer contains a pigment and a binder.

6. The process according to claim 1, wherein at least one additional layer is provided between the base paper and the cationic treatment material layer.

7. The process according to claim 1, wherein the coating layer is provided upon the cationic treatment material layer.

8. The process according to claim 1, wherein 0.5 to 3 g/m² is provided as the amount of the cationic treatment material layer.

9. The process according to claim 1, wherein 3 to 12 g/m² is provided as the amount of the coating layer.

10. A paper product to be used as printing paper, the paper product comprising a base paper which is formed from fiber-based raw material, and a coating provided to the surface of the base paper, wherein a treatment material layer which contains a cationic compound is provided on the base paper, at least on one of its surfaces, and a coating layer is provided on the cationic treatment material layer.

11. The paper product according to claim 10, wherein the cationic treatment material is a cationic surface-size, and a cationic surface-size layer is provided on the base paper, at least on one of its surfaces, and the coating layer is provided on the cationic surface-size layer.

12. The paper product according to claim 11, wherein the cationic surface-size layer contains a cationic polymeric and/or a cationic ionic compound.

13. The process according to claim 10, wherein the cationic treatment material layer contains a binder in addition to the cationic compound.

14. The process according to claim 13, wherein the cationic treatment material layer contains starch as the binder.

15. The paper product according to claim 10, wherein the coating layer contains a pigment and a binder.

16. The paper product according to claim 10, wherein the coating layer is provided upon the cationic treatment material layer.

17. The paper product according to claim 10, wherein at least one additional layer is provided between the base paper and the cationic treatment material layer.

18. A hybrid coating to be provided to at least one surface of a base paper which is formed from fiber-based raw material, wherein the hybrid coating contains at least two layers, wherein the first layer is a treatment material layer which contains a cationic compound, and the second layer is a coating layer.

19. The hybrid coating according to claim 18, wherein the cationic treatment material is a cationic surface-size.

20. The hybrid coating according to claim 19, wherein the cationic surface-size layer contains a cationic polymeric and/or a cationic ionic compound.

21. The hybrid coating according to claim 18, wherein the cationic treatment material layer contains a binder in addition to the cationic compound.

22. The hybrid coating according to claim 18, wherein the coating layer contains a pigment and a binder.

23. The hybrid coating according to claim 18, wherein the amount of the cationic treatment material layer is 0.5 to 3 g/m².

24. The hybrid coating according to claim 18, wherein the amount of the coating layer is 3 to 12 g/m².

25. A process for providing a hybrid coating to at least one surface of a base paper which is formed from fiber-based raw material, wherein the hybrid coating contains at least two layers, wherein the first layer is a treatment material layer which contains a cationic compound, and the second layer is a coating layer, and the hybrid coating is applied to the surface of the base paper in one or more steps.

26. The process according to claim 25, wherein the hybrid coating is applied to the surface of the base paper by an apparatus which is selected from the group of a size press, blade coater, spray coater, curtain coater, multilayer curtain coater, film coater, sizer coater, dry coater and their combinations.
